(19) United States
(12) Patent Application Publication
(10) Pub. No.: US 2016/0343529 A1
(43) Pub. Date: Nov. 24, 2016

(54) GAS CIRCUIT BREAKER

(71) Applicant: MITSUBISHI ELECTRIC CORPORATION, Tokyo (JP)

(72) Inventors: Kohei OTANI, Tokyo (JP); Tomohito MORI, Tokyo (JP); Daisuke YOSHIDA, Tokyo (JP)

(73) Assignee: MITSUBISHI ELECTRIC CORPORATION, Tokyo (JP)

(21) Appl. No.: 15/115,009

(22) PCT Filed: Feb. 24, 2014
(86) PCT No.: PCT/JP2014/054372

§ 371 Date: Jul. 28, 2016

(51) Int. Cl. H01H 71/02; H01H 9/30

(52) U.S. Cl. CPC H01H 71/0257; H01H 9/30

(57) ABSTRACT

A pressure vessel includes a main pipe and branch pipes branching off from the side surface of the main pipe. Reinforcing ribs are provided as reinforcing members on the side surfaces of the branch pipes. Among the reinforcing members, the reinforcing rib has a structure continuously extended between the branch pipes to relieve the concentrations of stress that occur at the bases of the branch pipes.

### FIELD

The present invention relates to a gas circuit breaker.

### BACKGROUND

Conventional gas circuit breakers include a gas circuit breaker body having a pressure vessel, bushings attached to the upper portions of the pressure vessel, and an operating device that is attached to the gas circuit breaker body and performs a breaking or closing operation by driving a movable contact in the pressure vessel. The operating device generally obtains the driving force to drive the movable contact from the energy stored in a torsion bar or a coil spring.

Pressure vessels used in conventional gas circuit breakers have a plurality of branch pipes branching off from a tank that is a main pipe. Reinforcing ribs are sometimes provided to the branch pipes for reinforcement.

In Patent Literature 1, projection pieces are provided over the surface of a pressure vessel to increase the strength of the entire pressure vessel.

### CITATION LIST

### Patent Literature

Patent Literature 1: Japanese Patent Application Laid-Open No. 2000-37008

### SUMMARY

### Technical Problem

The main pipe and the branch pipes constituting the pressure vessel of a gas circuit breaker have a problem in that high stresses occur at the bases of the branch pipes due to electromagnetic forces when a fault current is generated or due to acceleration responses caused by resonance during an earthquake.

As a measure against this, it is common to provide reinforcing ribs around the branch pipes to support them.

However, it has been found that reinforcing ribs with certain shapes cause the reinforcing ribs to press against the main pipe when stresses occur, resulting in more stress concentration. A reinforcing rib denting the main pipe due to stress concentration, for example, can lead to breakage of the main pipe.

In order to relieve stress concentration caused by reinforcing ribs, consideration has been given to increasing the plate thickness of the entire pressure vessel, changing the material of the pressure vessel to one with a higher strength, or providing projection pieces over the surface of the pressure vessel to increase the strength, as in Patent Literature 1; however, all of these lead to an increase in the weight of the pressure vessel, and thus are not preferable in terms of weight reduction. Further, the technique described in Patent Literature 1, which provides a large number of projection pieces, has a problem of increasing the cost.

The present invention has been made in view of the above and has an object of providing a gas circuit breaker with a pressure vessel that relieves stress concentrations, has a light weight, and also has a low manufacturing cost.

### Solution to Problem

In order to solve the above problems and achieve the object, a gas circuit breaker according to an aspect of the present invention is a gas circuit breaker that includes a pressure vessel including a main pipe disposed with an axis parallel to an installation surface and first and second branch pipes branching off from the main pipe obliquely upward and tilted away from each other; a plurality of reinforcing members that reinforce the first branch pipe; a plurality of reinforcing members that reinforce the second branch pipe; a breaking unit disposed in an insulating gas sealed in the pressure vessel; and first and second bushings connected to the first and second branch pipes, respectively; the gas circuit breaker including: a plate-shaped first reinforcing member fixed to a side surface of the first branch pipe on the second branch pipe side, disposed parallel to a direction of the axis and perpendicularly to the installation surface, and fixed to a side surface of the main pipe; a plate-shaped second reinforcing member fixed to a side surface of the second branch pipe on the first branch pipe side, disposed parallel to the direction of the axis and perpendicularly to the installation surface, and fixed to the side surface of the main pipe; and a stress-relieving member that relieves concentration of stress on the side surface of the main pipe due to the first and second reinforcing members, the stress-relieving member being fixed to the side surface of the main pipe and integrally connecting the first reinforcing member and the second reinforcing member in the direction of the axis or being interposed between and fixed to the first and second reinforcing members and the side surface of the main pipe.

### Advantageous Effects of Invention

The present invention achieves the effects of being able to provide a gas circuit breaker with a pressure vessel that relieves stress concentrations, has a light weight, and also has a low manufacturing cost.

### BRIEF DESCRIPTION OF DRAWINGS

FIG. 1 is a front view illustrating a configuration of a gas circuit breaker according to a first embodiment.

FIG. 2 is a front view illustrating a configuration of a pressure vessel of the gas circuit breaker according to the first embodiment.

FIGS. 3(a) and 3(b) are cross-sectional views along A-A in FIG. 2.

FIGS. 4(a) and 4(b) are side views illustrating a configuration of reinforcing ribs around branch pipes.

FIG. 5 is a diagram for explaining functions and effects of the first embodiment.

FIGS. 6(a) and 6(b) are cross-sectional views along A-A in FIG. 2.

FIG. 7 is a front view illustrating a configuration of a gas circuit breaker according to a third embodiment.

FIGS. 8(a) and 8(b) are side views illustrating a configuration of reinforcing ribs and reinforcing plates around branch pipes.

FIG. 9 is a diagram illustrating the manner in which stress concentrations occur due to electromagnetic forces in a conventional gas circuit breaker.

FIG. 10 is a diagram illustrating the manner in which stress concentrations occur due to resonance during an earthquake in the conventional gas circuit breaker.

### DESCRIPTION OF EMBODIMENTS

Hereinafter, a gas circuit breaker according to embodiments of the present invention will be described in detail with reference to the drawings. The embodiments are not intended to limit the present invention.

### First Embodiment

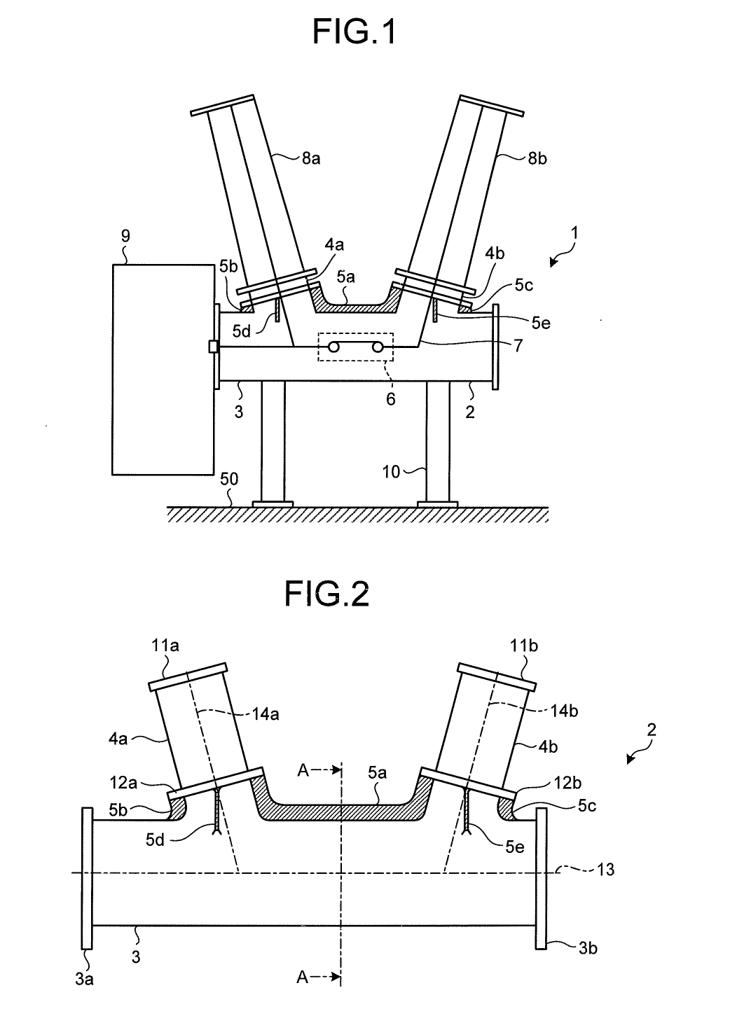

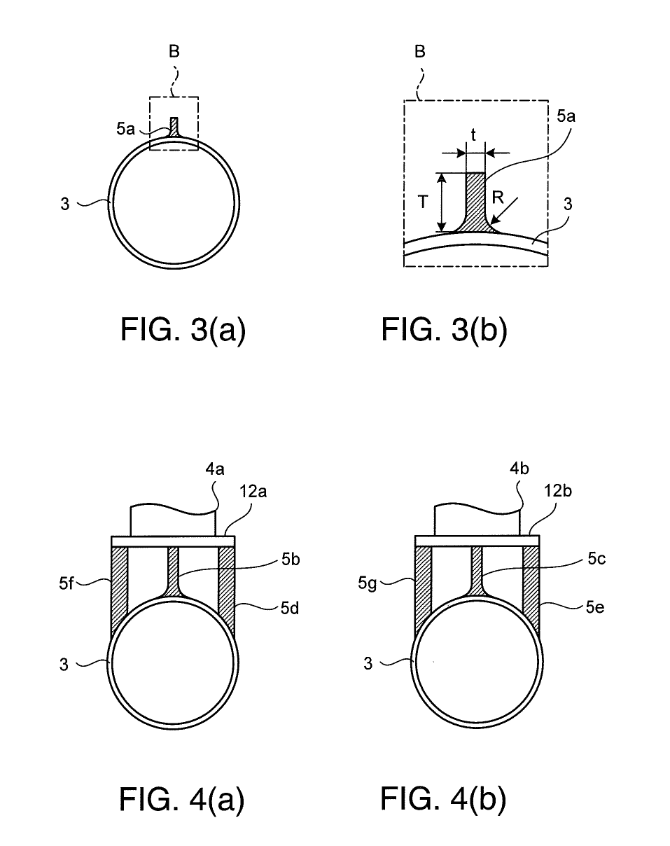

FIG. 1 is a front view illustrating a configuration of a gas circuit breaker according to the present embodiment. FIG. 1 also schematically illustrates part of the internal configuration. FIG. 2 is a front view illustrating a configuration of the pressure vessel of the gas circuit breaker according to the present embodiment. FIG. 3 is a cross-sectional view along A-A in FIG. 2. FIG. 3(b) is an enlarged view of a portion B in FIG. 3(a). FIGS. 4(a) and 4(b) are side views illustrating a configuration of reinforcing ribs around branch pipes. FIG. 4(a) is a side view illustrating a configuration of reinforcing ribs 5b, 5d, and 5f around a branch pipe 4a when the branch pipe 4a is viewed from the side where a branch pipe 4b is present. FIG. 4(b) is a side view illustrating a configuration of reinforcing ribs 5c, 5e, and 5g around the branch pipe 4b when the branch pipe 4b is viewed from the side where the branch pipe 4a is present. Hereinafter, with reference to FIGS. 1 to 4, the configuration of the gas circuit breaker according to the present embodiment will be described.

A gas circuit breaker 1 includes a pressure vessel 2, a breaking unit 6, a conductor 7, bushings 8a and 8b, an operating device 9, and a frame 10.

The pressure vessel 2 is a metal tank and includes a main pipe 3 and a pair of branch pipes 4a and 4b branching off from the side surface of the main pipe 3. The main pipe 3 is cylindrical and is disposed with an axis 13 parallel to an installation surface 50. The branch pipes 4a and 4b (first and second branch pipes) are provided such that they branch off from the side surface of the main pipe 3 obliquely upward and are tilted away from each other. FIG. 2 illustrates an axis 14a of the branch pipe 4a and an axis 14b of the branch pipe 4b. The branch pipes 4a and 4b are smaller in diameter than the main pipe 3. Flanges 3a and 3b are provided at both ends of the main pipe 3 in the axis 13 direction. A flange 11a is provided at the distal end of the branch pipe 4a, and a flange 11b is provided at the distal end of the branch pipe 4b.

The pressure vessel 2 is filled with an insulating gas, for example, sulfur hexafluoride gas. The breaking unit 6, which is an opening and closing unit including a movable contact, a fixed contact, an arc-extinguishing chamber, and others, is disposed in the main pipe 3. The breaking unit 6 is connected to the conductor 7. The conductor 7 is a current-carrying portion through which current flows. In FIG. 1, the gas circuit breaker 1 is in a closed state, for example. The pressure vessel 2 is mounted on the frame 10 placed on the installation surface 50.

The bushing 8a is connected to the branch pipe 4a, and the bushing 8b is connected to the branch pipe 4b. The distal ends of the bushings 8a and 8b (first and second bushings) are connected to power cables not illustrated. The conductor 7 provided in the pressure vessel 2 extends into the bushings 8a and 8b.

The operating device 9 is disposed at one end face of the pressure vessel 2 in the axis 13 direction, for example. The operating device 9 is a device to open and close the breaking unit 6 and has a connecting mechanism, an operating mechanism, an energy-storing mechanism, and others housed in an operation box.

Reinforcing ribs 5a, 5b, 5d, and 5f (a plurality of reinforcing members) for reinforcing the branch pipe 4a are provided on the side surface of the branch pipe 4a. The reinforcing ribs 5a, 5c, 5e, and 5g (a plurality of reinforcing members) for reinforcing the branch pipe 4b are provided on the side surface of the branch pipe 4b. The reinforcing ribs 5a to 5g are each formed from a plate-shaped metal member.

A flange-shaped base plate 12a (first base plate) is provided at an intermediate portion of the branch pipe 4a in the axis 14a direction on the main pipe 3 side. Specifically, the base plate 12a is provided in an annular shape on the outer periphery of the branch pipe 4a. The reinforcing ribs 5a, 5b, 5d, and 5f are fixed to the surface of the base plate 12a on the main pipe 3 side, to the side surface of the branch pipe 4a, and to the side surface of the main pipe 3, and they are provided around the branch pipe 4a for supporting and reinforcing the branch pipe 4a in the form of ribs. The reinforcing ribs 5a, 5b, 5d, and 5f are arranged in four directions orthogonal to each other, for example.

Likewise, a flange-shaped base plate 12b (second base plate) is provided at an intermediate portion of the branch pipe 4b in the axis 14b direction on the main pipe 3 side. Specifically, the base plate 12b is provided in an annular shape on the outer periphery of the branch pipe 4b. The reinforcing ribs 5a, 5c, 5e, and 5g are fixed to the surface of the base plate 12b on the main pipe 3 side, to the side surface of the branch pipe 4b, and to the side surface of the main pipe 3, and they are provided around the branch pipe 4b for supporting and reinforcing the branch pipe 4b in the form of ribs. The reinforcing ribs 5a, 5c, 5e, and 5g are arranged in four directions orthogonal to each other, for example.

The reinforcing rib 5a (inter-branch pipe reinforcing member) is disposed above the axis 13, is disposed parallel to the axis 13, and is disposed perpendicularly to the installation surface 50. The reinforcing rib 5a is fixed to the surface of the base plate 12a on the main pipe 3 side; fixed to the side surface of the branch pipe 4a on the branch pipe 4b side; extended on the side surface of the main pipe 3 in the axis 13 direction and fixed to the side surface of the main pipe 3; fixed to the side surface of the branch pipe 4b on the branch pipe 4a side; and further fixed to the surface of the base plate 12b on the main pipe 3 side. Thus, the reinforcing rib 5a has a structure extended continuously between the branch pipes 4a and 4b. The reinforcing rib 5a connects between the branch pipes 4a and 4b, and is used as a reinforcing member shared by the branch pipes 4a and 4b.

FIG. 3 illustrates the cross-sectional shape of the reinforcing rib 5a orthogonal to the axis 13 on the side surface of the main pipe 3. The reinforcing rib 5a has a plate shape with height T and width t (<T), and is formed in a smooth curved shape (e.g. arc shape) at both of the side surfaces at the end portion (lower end portion) on the main pipe 3 side so as not to form corners at the joint between the reinforcing rib 5a and the main pipe 3. In the illustrated example, both of the side surfaces at the lower end portion of the reinforcing rib 5a are formed in an arc shape with curvature R. This configuration can relieve the concentration of stress on the main pipe 3 due to the reinforcing rib 5a.

The reinforcing rib 5b (third reinforcing member) is disposed above the axis 13 and parallel to the reinforcing rib 5a. The reinforcing rib 5b is fixed to the surface of the base plate 12a on the main pipe 3 side; fixed to the side surface of the branch pipe 4a on the side opposite the branch pipe 4b side; and fixed to the side surface of the main pipe 3 above the axis 13. The reinforcing rib 5b is disposed opposite the reinforcing rib 5a across the branch pipe 4a in the axis 13 direction. As with the reinforcing rib 5a, the reinforcing rib 5b can be formed in a smooth curved shape (e.g. arc shape) at both of the side surfaces at the end portion (lower end portion) on the main pipe 3 side so as not to form corners at the joint between the reinforcing rib 5b and the main pipe 3 (FIG. 4(a)).

The reinforcing rib 5d (fourth reinforcing member) is disposed at right angles to the reinforcing rib 5a. The reinforcing rib 5d is fixed to the surface of the base plate 12a on the main pipe 3 side; fixed to the side surface of the branch pipe 4a; and fixed to the side surface of the main pipe 3. The reinforcing rib 5d supports and reinforces the branch pipe 4a in a direction orthogonal to the reinforcing ribs 5a and 5b.

The reinforcing rib 5f (fifth reinforcing member) is disposed at right angles to the reinforcing rib 5a. The reinforcing rib 5f is fixed to the surface of the base plate 12a on the main pipe 3 side; fixed to the side surface of the branch pipe 4a; and fixed to the side surface of the main pipe 3. The reinforcing rib 5f is disposed opposite the reinforcing rib 5d in a direction orthogonal to the reinforcing ribs 5a and 5b.

The reinforcing rib 5c (sixth reinforcing member) is disposed above the axis 13 and parallel to the reinforcing rib 5a. The reinforcing rib 5c is fixed to the surface of the base plate 12b on the main pipe 3 side; fixed to the side surface of the branch pipe 4b on the side opposite the branch pipe 4a side; and fixed to the side surface of the main pipe 3 above the axis 13. The reinforcing rib 5c is disposed opposite the reinforcing rib 5a across the branch pipe 4b in the axis 13 direction. As with the reinforcing rib 5a, the reinforcing rib 5c can be formed in a smooth curved shape (e.g. arc shape) at both of the side surfaces at the end portion (lower end portion) on the main pipe 3 side so as not to form corners at the joint between the reinforcing rib 5c and the main pipe 3 (FIG. 4(b)).

The reinforcing rib 5e (seventh reinforcing member) is disposed at right angles to the reinforcing rib 5a. The reinforcing rib 5e is fixed to the surface of the base plate 12b on the main pipe 3 side; fixed to the side surface of the branch pipe 4b; and fixed to the side surface of the main pipe 3. The reinforcing rib 5e supports and reinforces the branch pipe 4b in a direction orthogonal to the reinforcing ribs 5a and 5c.

The reinforcing rib 5g (eighth reinforcing member) is disposed at right angles to the reinforcing rib 5a. The reinforcing rib 5g is fixed to the surface of the base plate 12b on the main pipe 3 side; fixed to the side surface of the branch pipe 4b; and fixed to the side surface of the main pipe 3. The reinforcing rib 5g is disposed opposite the reinforcing rib 5e in a direction orthogonal to the reinforcing ribs 5a and 5c to support and reinforce the branch pipe 4b.

The reinforcing ribs 5a to 5g can be fixed to the pressure vessel 2 by welding, for example. When the size of the pressure vessel 2 is relatively small, the pressure vessel 2 can be formed as a casting. In this case, the reinforcing ribs 5a to 5g can be formed integrally with the pressure vessel 2 by providing portions to form the reinforcing ribs 5a to 5g in the mold from which the pressure vessel 2 is formed.

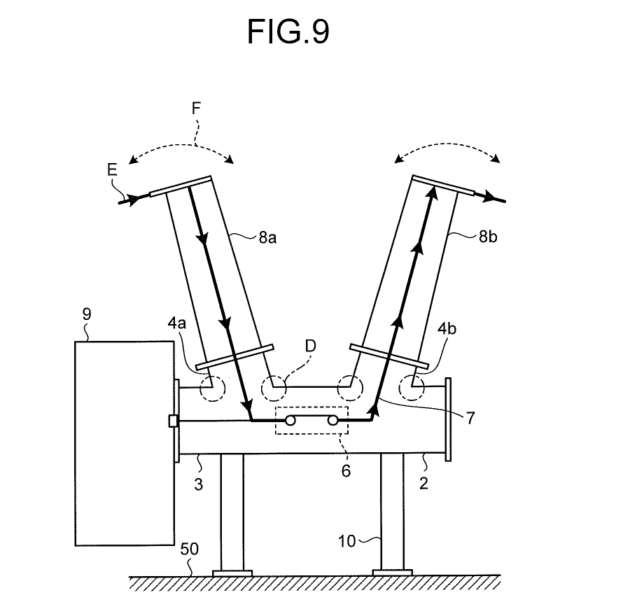

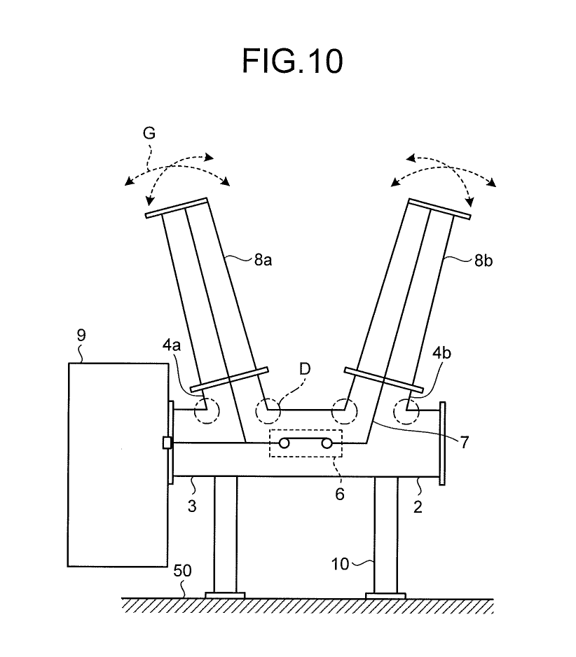

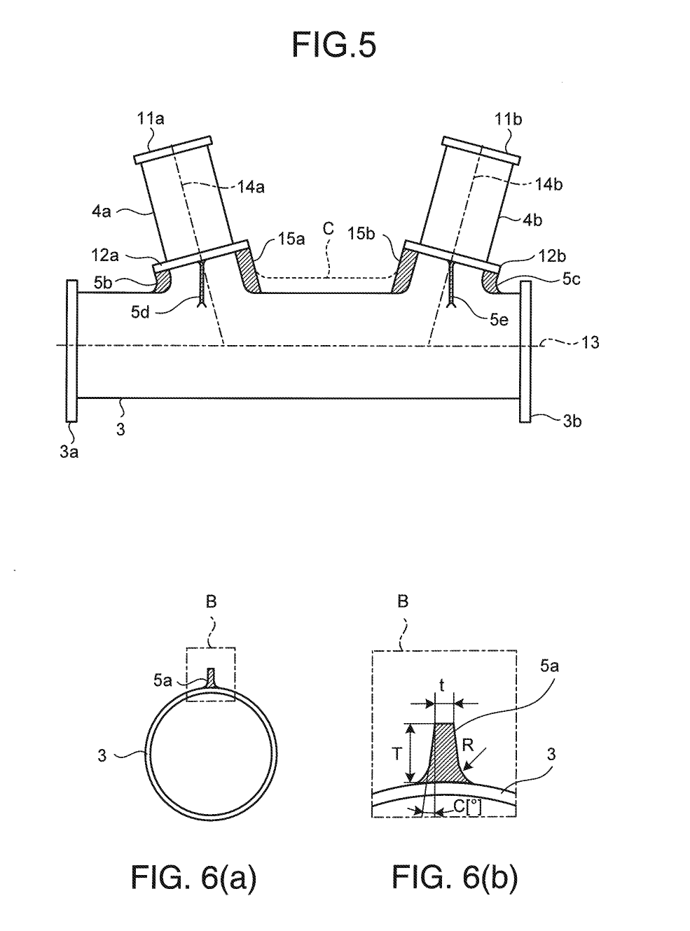

Next, with reference to FIGS. 9 and 10, problems with a conventional gas circuit breaker will be described. FIG. 9 is a diagram illustrating the manner in which stress concentrations occur due to electromagnetic forces in a conventional gas circuit breaker. FIG. 10 is a diagram illustrating the manner in which stress concentrations occur due to resonance during an earthquake in the conventional gas circuit breaker. In FIGS. 9 and 10, the same components as those in FIG. 1 are denoted by the same reference numerals.

In FIG. 9, the gas circuit breaker is in a closed state and current flows through the conductor 7. The direction of the current flow is shown by arrows E in the figure. When current flows through the conductor 7, magnetic fields are generated around the conductor 7 and electromagnetic forces act on the conductor 7 due to the magnetic fields. As shown by F in the figure, electromagnetic forces act on the bushings 8a and 8b connected to the branch pipes 4a and 4b. Since the bushings 8a and 8b have a long length, the electromagnetic forces are great. Therefore, stresses due to the electromagnetic forces concentrate at the bases of the branch pipes 4a and 4b shown by D in the figure. In the event of a short-circuit or a ground fault, in particular, an excessive current flows through the conductor 7 and the electromagnetic forces become even greater, resulting in the concentration of even more stresses at the bases of the branch pipes 4a and 4b.

FIG. 10 illustrates the manner in which stress concentrations occur due to resonance during an earthquake. In FIG. 9, the direction of the electromagnetic forces is mainly along the axis direction of the main pipe 3, and stress concentration portions are on both sides of the branch pipes 4a and 4b in the same direction. Earthquake vibrations, however, can occur in directions that are three-dimensional. In FIG. 10, the directions in which resonance of the bushings 8a and 8b occur are shown by arrows G, and portions at which stresses concentrate are shown by D in the figure.

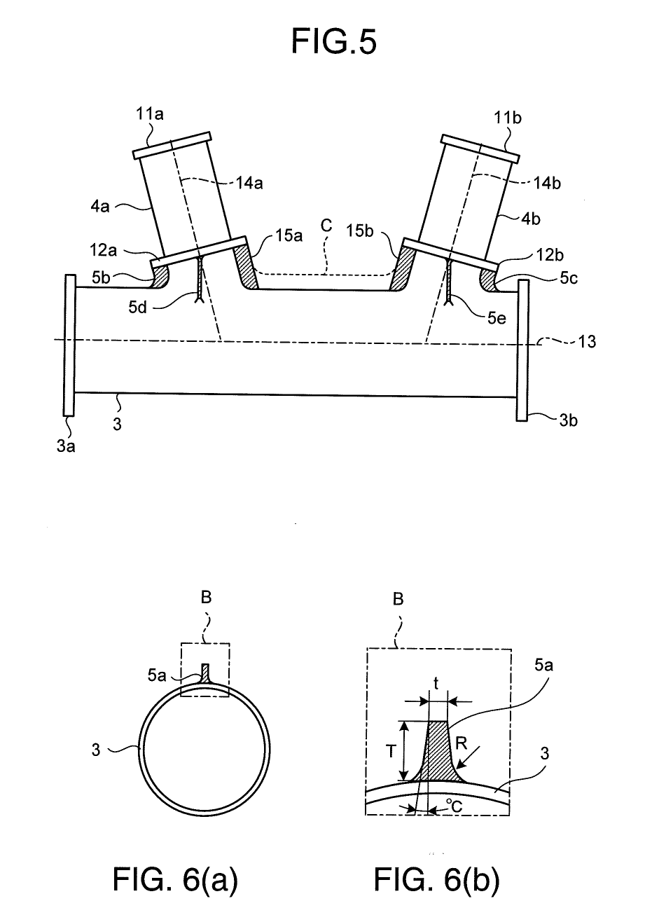

Next, with reference to FIGS. 1 to 5, functions and effects of the present embodiment will be described. FIG. 5 is a diagram for explaining functions and effects of the present embodiment. In FIG. 5, the same components as those in FIG. 2 are denoted by the same reference numerals.

In FIG. 5, reinforcing ribs 15a, 5b, 5d, and 5f for reinforcing the branch pipe 4a are provided to the side surface of the branch pipe 4a. Reinforcing ribs 15b, 5c, 5e, and 5g for reinforcing the branch pipe 4b are provided to the side surface of the branch pipe 4b. The reinforcing rib 15a is separate from the reinforcing rib 15b. Specifically, the reinforcing rib 15a, in the same way as the reinforcing rib 5b, is provided only near the base of the branch pipe 4a, and the reinforcing rib 15b, in the same way as the reinforcing rib 5c, is provided only near the base of the branch pipe 4b. The reinforcing rib 5f is opposite the reinforcing rib 5d, and the reinforcing rib 5g is opposite the reinforcing rib 5e. Neither of the reinforcing ribs 5f and 5g is shown in the figure. The reinforcing ribs 15a, 5b, 5d, 5f, 15b, 5c, 5e, and 5g are each formed from a plate-shaped metal member.

In FIG. 5, the branch pipe 4a is reinforced by the reinforcing ribs 15a, 5b, 5d, and 5f, and the branch pipe 4b is reinforced by the reinforcing ribs 15b, 5c, 5e, and 5g; therefore, stress concentration due to electromagnetic forces or resonance during an earthquake can be relieved.

However, the reinforcing ribs 15a, 5b, 5d, 5f, 15b, 5c, 5e, and 5g, which are plate-shaped, are likely to cause stresses to concentrate at joints between these ribs and the main pipe 3, and they can press against and break the main pipe 3 when stresses occur.

Thus, in the present embodiment, as illustrated in FIG. 2, the reinforcing rib 5a continuously extended between the branch pipes 4a and 4b is provided to increase the relief of stress concentration at the joint between the reinforcing rib 5a and the main pipe 3. Specifically, in FIG. 5, a stress-relieving member to integrally connect the reinforcing ribs 15a and 15b (first and second reinforcing members) is provided at a portion shown by a dotted line C in the configuration to cause the single reinforcing rib 5a (inter-branch pipe reinforcing member) to also function as a stress-relieving member, thereby relieving the concentrations of stress at the sides of the branch pipes 4a and 4b opposite to each other.

Thus, the provision of the reinforcing rib 5a can relieve stress concentrations that occur in the pressure vessel 2, allowing the thickness of the pressure vessel 2 to be reduced and allowing the pressure vessel 2 to be reduced in size and weight and also reduced in cost.

In the present embodiment, as illustrated in FIG. 3, both of the side surfaces of the reinforcing rib 5a at the end portion on the main pipe 3 side are formed in a smooth curved shape (e.g. arc shape) so as not to form corners at the joint between the reinforcing rib 5a and the main pipe 3. This configuration can still further relieve the concentration of stress due to the reinforcing rib 5a on the main pipe 3. The same effect can be obtained at the reinforcing ribs 5b, 5c, 5d, 5e, 5f, and 5g by making their both side surfaces at the end portions on the main pipe 3 side in a smooth curved shape (e.g. arc shape).

Further, in the present embodiment, the base plates 12a and 12b are provided to increase the strength of the reinforcement.

The number of reinforcing members for reinforcing the branch pipes 4a and 4b, respectively, can be made larger than that in the illustrated example. For the purpose of relieving stress concentration due to electromagnetic forces, it is possible to provide configurations of only the reinforcing ribs 5a, 5b, and 5c. For the purpose of relieving stress concentration during an earthquake, reinforcing members orthogonal to the reinforcing ribs 5a, 5b, and 5c are provided, and it is preferable to provide them as in the illustrated example (reinforcing ribs 5d, 5f, 5e, and 5g) for strength and ease of manufacture.

In Patent Literature 1, the projection pieces are provided over the surface of the pressure vessel, but a continuous projection piece is not provided from the branch pipes to the main pipe. The projection pieces are provided on the branch pipes and the main pipe, individually, to increase the strength of the entire pressure vessel, which is different in configuration from the present embodiment. The technique described in Patent Literature 1, which provides a large number of projection pieces, increases the weight of the pressure vessel and also increases the cost.

### Second Embodiment

In the first embodiment, the cross-sectional shape of the reinforcing rib 5a on the side surface of the main pipe 3 is shown in FIG. 3. In the present embodiment, the cross-sectional shape of the reinforcing rib 5a is shown in FIGS. 6(a) and 6(b). The other configuration in the present embodiment is identical to that in the first embodiment.

As illustrated in FIGS. 6(a) and 6(b), the reinforcing rib 5a has a plate shape with height T and width t (<T) at the upper end. The reinforcing rib 5a has a tapered shape with its width increasing from the upper end to the lower end. In the figure, the taper angle is shown by C[° ]. Further, as in the first embodiment, the reinforcing rib 5a is formed in a smooth curved shape (e.g. arc shape) at both of the side surfaces at the end portion (lower end portion) on the main pipe 3 side so as not to form corners at the joint between the reinforcing rib 5a and the main pipe 3.

This configuration can relieve the concentration of stress on the main pipe 3 due to the reinforcing rib 5a more than in the first embodiment.

### Third Embodiment

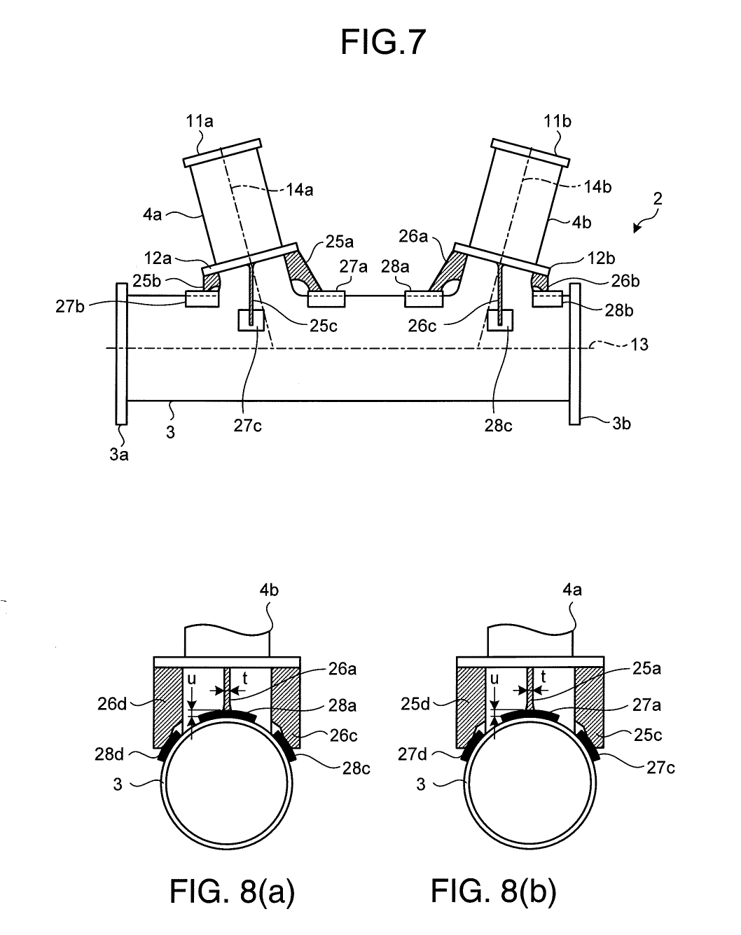

FIG. 7 is a front view illustrating a configuration of a gas circuit breaker according to the present embodiment.

FIG. 7 also schematically illustrates part of the internal configuration. FIGS. 8(a) and 8(b) are side views illustrating a configuration of reinforcing ribs and reinforcing plates around branch pipes. FIG. 8(a) is a side view illustrating a configuration of reinforcing ribs 26a, 26c, and 26d and reinforcing plates 28a, 28c, and 28d around the branch pipe 4b when the branch pipe 4b is viewed from the branch pipe 4a side. FIG. 8(b) is a side view illustrating a configuration of reinforcing ribs 25a, 25c, and 25d and reinforcing plates 27a, 27c, and 27d around the branch pipe 4a when the branch pipe 4a is viewed from the branch pipe 4b side. In FIGS. 7 and 8, the same components as those in FIGS. 1 to 4 are denoted by the same reference numerals. Hereinafter, with reference to FIGS. 7 and 8, the configuration of the present embodiment will be described.

As illustrated in FIGS. 7 and 8, the pressure vessel 2 includes the main pipe 3 and a pair of branch pipes 4a and 4b branching off from the side surface of the main pipe 3. The reinforcing ribs 25a to 25d and the reinforcing plates 27a to 27d are provided around the branch pipe 4a. The reinforcing ribs 26a to 26d and the reinforcing plates 28a to 28d are provided around the branch pipe 4b.

The reinforcing ribs 25a to 25d (a plurality of reinforcing members) for reinforcing the branch pipe 4a are provided on the side surface of the branch pipe 4a. Further, the reinforcing plates 27a to 27d are provided as stress-relieving members between the reinforcing ribs 25a to 25d and the side surface of the main pipe 3, respectively. The reinforcing ribs 26a to 26d (a plurality of reinforcing members) for reinforcing the branch pipe 4b are provided on the side surface of the branch pipe 4b. Further, the reinforcing plates 28a to 28d are provided as stress-relieving members between the reinforcing ribs 26a to 26d and the side surface of the main pipe 3, respectively. The reinforcing ribs 25a to 25d and 26a to 26d, and the reinforcing plates 27a to 27d and 28a to 28d are each formed from a plate-shaped metal member. The reinforcing ribs 25a to 25d are arranged in four directions orthogonal to each other, for example. The reinforcing ribs 26a to 26d are arranged in four directions orthogonal to each other, for example.

The reinforcing rib 25a (first reinforcing member) is disposed above the axis 13, is disposed parallel to the axis 13, and is disposed perpendicularly to the installation surface (not illustrated). The reinforcing rib 25a is fixed to the surface of the base plate 12a on the main pipe 3 side; fixed to the side surface of the branch pipe 4a on the branch pipe 4b side; and fixed to the reinforcing plate 27a fixed to the side surface of the main pipe 3. Specifically, the lower end of the reinforcing rib 25a is placed on the reinforcing plate 27a and fixed to the reinforcing plate 27a by welding, for example. The reinforcing rib 25a has a notch so that the reinforcing rib 25a does not make contact with the base (joint) of the branch pipe 4a. This configuration facilitates the work to join the reinforcing rib 25a to the pressure vessel 2 by welding.

The reinforcing plate 27a (first reinforcing plate) is interposed between the reinforcing rib 25a and the side surface of the main pipe 3. The reinforcing plate 27a is fixed to the side surface of the main pipe 3 by welding, for example. The reinforcing plate 27a is a seat with an arch-shaped cross-section, and it has a curved shape with an inside diameter equal to the outside diameter of the main pipe 3. The contact area between the reinforcing plate 27a and the main pipe 3 is greater than the contact area between the reinforcing rib 25a and the reinforcing plate 27a. The thickness u of the reinforcing plate 27a can be made greater than the thickness t of the reinforcing rib 25a. The provision of this reinforcing plate 27a can relieve the concentration of stress on the main pipe 3 due to the reinforcing rib 25a.

The reinforcing rib 25b (third reinforcing member) is disposed above the axis 13 and parallel to the reinforcing rib 25a. The reinforcing rib 25b is fixed to the surface of the base plate 12a on the main pipe 3 side; fixed to the side surface of the branch pipe 4a on the side opposite the branch pipe 4b side; and fixed to the reinforcing plate 27b fixed to the side surface of the main pipe 3. Specifically, the lower end of the reinforcing rib 25b is placed on the reinforcing plate 27b and fixed to the reinforcing plate 27b by welding, for example. The reinforcing rib 25b has a notch so that the reinforcing rib 25b does not make contact with the base (joint) of the branch pipe 4a. This configuration facilitates the work to join the reinforcing rib 25b to the pressure vessel 2 by welding. The reinforcing rib 25b is disposed opposite the reinforcing rib 25a across the branch pipe 4a in the axis 13 direction.

The reinforcing plate 27b (third reinforcing plate) is interposed between the reinforcing rib 25b and the side surface of the main pipe 3. The reinforcing plate 27b is fixed to the side surface of the main pipe 3 by welding, for example. The reinforcing plate 27b is a seat with an arch-shaped cross-section, and it has a curved shape with an inside diameter equal to the outside diameter of the main pipe 3. The contact area between the reinforcing plate 27b and the main pipe 3 is greater than the contact area between the reinforcing rib 25b and the reinforcing plate 27b. The thickness u of the reinforcing plate 27b can be made greater than the thickness t of the reinforcing rib 25b. The provision of this reinforcing plate 27b can relieve the concentration of stress on the main pipe 3 due to the reinforcing rib 25b.

The reinforcing rib 25c (fourth reinforcing member) is disposed at right angles to the reinforcing rib 25a. The reinforcing rib 25c is fixed to the surface of the base plate 12a on the main pipe 3 side; fixed to the side surface of the branch pipe 4a; and fixed to the reinforcing plate 27c fixed to the side surface of the main pipe 3. Specifically, the lower end of the reinforcing rib 25c is placed on the reinforcing plate 27c and fixed to the reinforcing plate 27c by welding, for example. The reinforcing rib 25c has a notch so that the reinforcing rib 25c does not make contact with the base (joint) of the branch pipe 4a. This configuration facilitates the work to join the reinforcing rib 25c to the pressure vessel 2 by welding. The reinforcing rib 25c supports and reinforces the branch pipe 4a in a direction orthogonal to the reinforcing ribs 25a and 25b.

The reinforcing plate 27c (fourth reinforcing plate) is interposed between the reinforcing rib 25c and the side surface of the main pipe 3. The reinforcing plate 27c is fixed to the side surface of the main pipe 3 by welding, for example. The reinforcing plate 27c is a seat with an arch-shaped cross-section, and it has a curved shape with an inside diameter equal to the outside diameter of the main pipe 3. The contact area between the reinforcing plate 27c and the main pipe 3 is greater than the contact area between the reinforcing rib 25c and the reinforcing plate 27c. The thickness u of the reinforcing plate 27c can be made greater than the thickness t of the reinforcing rib 25c. The provision of this reinforcing plate 27c can relieve the concentration of stress on the main pipe 3 due to the reinforcing rib 25c.

The reinforcing rib 25d (fifth reinforcing member) is disposed at right angles to the reinforcing rib 25a. The reinforcing rib 25d is fixed to the surface of the base plate 12a on the main pipe 3 side; fixed to the side surface of the branch pipe 4a; and fixed to the reinforcing plate 27d fixed to the side surface of the main pipe 3. Specifically, the lower end of the reinforcing rib 25d is placed on the reinforcing plate 27d and fixed to the reinforcing plate 27d by welding, for example. The reinforcing rib 25d has a notch so that the reinforcing rib 25d does not make contact with the base (joint) of the branch pipe 4a. This configuration facilitates the work to join the reinforcing rib 25d to the pressure vessel 2 by welding. The reinforcing rib 25d is disposed opposite the reinforcing rib 25c in a direction orthogonal to the reinforcing ribs 25a and 25b.

The reinforcing plate 27d (fifth reinforcing plate) is fixed to the side surface of the main pipe 3 by welding, for example. The reinforcing plate 27d is a seat with an arch-shaped cross-section, and it has a curved shape with an inside diameter equal to the outside diameter of the main pipe 3. The contact area between the reinforcing plate 27d and the main pipe 3 is greater than the contact area between the reinforcing rib 25d and the reinforcing plate 27d. The thickness u of the reinforcing plate 27d can be made greater than the thickness t of the reinforcing rib 25d. The provision of this reinforcing plate 27d can relieve the concentration of stress on the main pipe 3 due to the reinforcing rib 25d.

The reinforcing rib 26a (second reinforcing member) is disposed above the axis 13, is disposed parallel to the axis 13, and is disposed perpendicularly to the installation surface (not illustrated). The reinforcing rib 26a is fixed to the surface of the base plate 12b on the main pipe 3 side; fixed to the side surface of the branch pipe 4b on the branch pipe 4a side; and fixed to the reinforcing plate 28a fixed to the side surface of the main pipe 3. Specifically, the lower end of the reinforcing rib 26a is placed on the reinforcing plate 28a and fixed to the reinforcing plate 28a by welding, for example. The reinforcing rib 26a has a notch so that the reinforcing rib 26a does not make contact with the base (joint) of the branch pipe 4b. This configuration facilitates the work to join the reinforcing rib 26a to the pressure vessel 2 by welding.

The reinforcing plate 28a (second reinforcing plate) is interposed between the reinforcing rib 26a and the side surface of the main pipe 3. The reinforcing plate 28a is fixed to the side surface of the main pipe 3 by welding, for example. The reinforcing plate 28a is a seat with an arch-shaped cross-section, and it has a curved shape with an inside diameter equal to the outside diameter of the main pipe 3. The contact area between the reinforcing plate 28a and the main pipe 3 is greater than the contact area between the reinforcing rib 26a and the reinforcing plate 28a. The thickness u of the reinforcing plate 28a can be made greater than the thickness t of the reinforcing rib 26a. The provision of this reinforcing plate 28a can relieve the concentration of stress on the main pipe 3 due to the reinforcing rib 26a.

The reinforcing rib 26b (sixth reinforcing member) is disposed above the axis 13 and parallel to the reinforcing rib 26a. The reinforcing rib 26b is fixed to the surface of the base plate 12b on the main pipe 3 side; fixed to the side surface of the branch pipe 4b on the side opposite the branch pipe 4a side; and fixed to the reinforcing plate 28b fixed to the side surface of the main pipe 3. Specifically, the lower end of the reinforcing rib 26b is placed on the reinforcing plate 28b and fixed to the reinforcing plate 28b by welding, for example. The reinforcing rib 26b has a notch so that the reinforcing rib 26b does not make contact with the base (joint) of the branch pipe 4b. This configuration facilitates the work to join the reinforcing rib 26b to the pressure vessel 2 by welding. The reinforcing rib 26b is disposed opposite the reinforcing rib 26a across the branch pipe 4b in the axis 13 direction.

The reinforcing plate 28b (sixth reinforcing plate) is interposed between the reinforcing rib 26b and the side surface of the main pipe 3. The reinforcing plate 28b is fixed to the side surface of the main pipe 3 by welding, for example. The reinforcing plate 28b is a seat with an arch-shaped cross-section, and it has a curved shape with an inside diameter equal to the outside diameter of the main pipe 3. The contact area between the reinforcing plate 28b and the main pipe 3 is greater than the contact area between the reinforcing rib 26b and the reinforcing plate 28b. The thickness u of the reinforcing plate 28b can be made greater than the thickness t of the reinforcing rib 26b. The provision of this reinforcing plate 28b can relieve the concentration of stress on the main pipe 3 due to the reinforcing rib 26b.

The reinforcing rib 26c (seventh reinforcing member) is disposed at right angles to the reinforcing rib 26a. The reinforcing rib 26c is fixed to the surface of the base plate 12b on the main pipe 3 side; fixed to the side surface of the branch pipe 4b; and fixed to the reinforcing plate 28c fixed to the side surface of the main pipe 3. Specifically, the lower end of the reinforcing rib 26c is placed on the reinforcing plate 28c and fixed to the reinforcing plate 28c by welding, for example. The reinforcing rib 26c has a notch so that the reinforcing rib 26c does not make contact with the base (joint) of the branch pipe 4b. This configuration facilitates the work to join the reinforcing rib 26c to the pressure vessel 2 by welding. The reinforcing rib 26c supports and reinforces the branch pipe 4b in a direction orthogonal to the reinforcing ribs 26a and 26b.

The reinforcing plate 28c (seventh reinforcing plate) is interposed between the reinforcing rib 26c and the side surface of the main pipe 3. The reinforcing plate 28c is fixed to the side surface of the main pipe 3 by welding, for example. The reinforcing plate 28c is a seat with an arch-shaped cross-section, and it has a curved shape with an inside diameter equal to the outside diameter of the main pipe 3. The contact area between the reinforcing plate 28c and the main pipe 3 is greater than the contact area between the reinforcing rib 26c and the reinforcing plate 28c. The thickness u of the reinforcing plate 28c can be made greater than the thickness t of the reinforcing rib 26c. The provision of this reinforcing plate 28c can relieve the concentration of stress on the main pipe 3 due to the reinforcing rib 26c.

The reinforcing rib 26d (eighth reinforcing member) is disposed at right angles to the reinforcing rib 26a. The reinforcing rib 26d is fixed to the surface of the base plate 12b on the main pipe 3 side; fixed to the side surface of the branch pipe 4b; and fixed to the reinforcing plate 28d fixed to the side surface of the main pipe 3. Specifically, the lower end of the reinforcing rib 26d is placed on the reinforcing plate 28d and fixed to the reinforcing plate 28d by welding, for example. The reinforcing rib 26d has a notch so that the reinforcing rib 26d does not make contact with the base (joint) of the branch pipe 4b. This configuration facilitates the work to join the reinforcing rib 26d to the pressure vessel 2 by welding. The reinforcing rib 26d is disposed opposite the reinforcing rib 26c in a direction orthogonal to the reinforcing ribs 26a and 26b.

The reinforcing plate 28d (eighth reinforcing plate) is interposed between the reinforcing rib 26d and the side surface of the main pipe 3. The reinforcing plate 28d is fixed to the side surface of the main pipe 3 by welding, for example. The reinforcing plate 28d is a seat with an arch-shaped cross-section, and it has a curved shape with an inside diameter equal to the outside diameter of the main pipe 3. The contact area between the reinforcing plate 28d and the main pipe 3 is greater than the contact area between the reinforcing rib 26d and the reinforcing plate 28d. The thickness u of the reinforcing plate 28d can be made greater than the thickness t of the reinforcing rib 26d. The provision of this reinforcing plate 28d can relieve the concentration of stress on the main pipe 3 due to the reinforcing rib 26d.

The other configuration of the present embodiment is identical to that in the first embodiment.

According to the present embodiment, the arch-shaped reinforcing plates 27a to 27d and 28a to 28d, having an inside diameter equal to the outside diameter of the main pipe 3, are provided between the main pipe 3 and the reinforcing ribs 25a to 25d and 26a to 26d; therefore, the concentrations of stress at the main pipe 3 caused by the reinforcing ribs 25a to 25d and 26a to 26d can be relieved.

Although the present embodiment has a configuration in which reinforcing plates are provided between the main pipe 3 and all of the reinforcing ribs 25a to 25d and 26a to 26d, it is needless to say that even a partial configuration thereof in which the reinforcing plate 27a is provided between the main pipe 3 and the reinforcing rib 25a and the reinforcing plate 28a is provided between the main pipe 3 and the reinforcing rib 26a, for example, can also provide an effect of relieving stress concentration.

### INDUSTRIAL APPLICABILITY

As above, the present invention is useful as a gas circuit breaker.

### REFERENCE SIGNS LIST

1 gas circuit breaker, 2 pressure vessel, 3 main pipe, 3a and 3b, 11a and 11b flange, 4a and 4b branch pipe, 5a to 5g, 15a, 15b, 25a to 25d, 26a to 26d reinforcing rib, 6 breaking unit, 7 conductor, 8a and 8b bushing, 9 operating device, 10 frame, 12a and 12b base plate, 13, 14a, and 14b axis, 27a to 27d and 28a to 28d reinforcing plate, 50 installation surface.

1. A gas circuit breaker that includes a pressure vessel including a main pipe disposed with an axis parallel to an installation surface and first and second branch pipes branching off from the main pipe obliquely upward and tilted away from each other; a plurality of reinforcing members that reinforce the first branch pipe; a plurality of reinforcing members that reinforce the second branch pipe; a breaking unit disposed in an insulating gas sealed in the pressure vessel; and first and second bushings connected to the first and second branch pipes, respectively; the gas circuit breaker comprising:
a plate-shaped first reinforcing member fixed to a side surface of the first branch pipe on the second branch pipe side, disposed parallel to a direction of the axis and perpendicularly to the installation surface, and fixed to a side surface of the main pipe;
a plate-shaped second reinforcing member fixed to a side surface of the second branch pipe on the first branch pipe side, disposed parallel to the direction of the axis and perpendicularly to the installation surface, and fixed to the side surface of the main pipe; and
a stress-relieving member that relieves concentration of stress on the side surface of the main pipe due to the first and second reinforcing members, the stress-relieving member being fixed to the side surface of the main pipe and integrally connecting the first reinforcing member and the second reinforcing member in the direction of the axis or being interposed between and fixed to the first and second reinforcing members and the side surface of the main pipe.

2. The gas circuit breaker according to claim 1, wherein
the first reinforcing member and the second reinforcing member are integrally connected by the stress-relieving member in the direction of the axis to form a single plate-shaped inter-branch pipe reinforcing member, and
the inter-branch pipe reinforcing member is fixed to the side surface of the first branch pipe on the second branch pipe side, fixed to the side surface of the main pipe above the axis, and fixed to the side surface of the second branch pipe on the first branch pipe side.

3. The gas circuit breaker according to claim 2, further comprising:
a flange-shaped first base plate provided to the first branch pipe; and
a flange-shaped second base plate provided to the second branch pipe, wherein
the inter-branch pipe reinforcing member is also fixed to a surface of the first base plate on the main pipe side and to a surface of the second base plate on the main pipe side.

4. The gas circuit breaker according to claim 2, wherein in a cross section of the inter-branch pipe reinforcing member orthogonal to the axis on the side surface of the main pipe, the inter-branch pipe reinforcing member is formed in a smooth curved shape at both side surfaces thereof at a lower end portion so as not to form a corner at a joint between the inter-branch pipe reinforcing member and the main pipe.

5. The gas circuit breaker according to claim 4, wherein the inter-branch pipe reinforcing member has a tapered shape in the cross section with a width increasing from an upper end to a lower end.

6. The gas circuit breaker according to claim 3, further comprising:
a plate-shaped third reinforcing member disposed parallel to the inter-branch pipe reinforcing member above the axis, fixed to the side surface of the first branch pipe on a side opposite the second branch pipe side, fixed to the surface of the first base plate on the main pipe side, and fixed to the side surface of the main pipe;
a plate-shaped fourth reinforcing member disposed at right angles to the inter-branch pipe reinforcing member, fixed to the side surface of the first branch pipe, fixed to the surface of the first base plate on the main pipe side, and fixed to the side surface of the main pipe;
a plate-shaped fifth reinforcing member disposed at right angles to the inter-branch pipe reinforcing member, disposed opposite the fourth reinforcing member in a direction orthogonal to the inter-branch pipe reinforcing member, fixed to the side surface of the first branch pipe, fixed to the surface of the first base plate on the main pipe side, and fixed to the side surface of the main pipe;
a plate-shaped sixth reinforcing member disposed parallel to the inter-branch pipe reinforcing member above the axis, fixed to the side surface of the second branch pipe on a side opposite the first branch pipe side, fixed to the surface of the second base plate on the main pipe side, and fixed to the side surface of the main pipe;
a plate-shaped seventh reinforcing member disposed at right angles to the inter-branch pipe reinforcing member, fixed to the side surface of the second branch pipe, fixed to the surface of the second base plate on the main pipe side, and fixed to the side surface of the main pipe; and
a plate-shaped eighth reinforcing member disposed at right angles to the inter-branch pipe reinforcing member, disposed opposite the seventh reinforcing member in a direction orthogonal to the inter-branch pipe reinforcing member, fixed to the side surface of the second branch pipe, fixed to the surface of the second base plate on the main pipe side, and fixed to the side surface of the main pipe.

7. The gas circuit breaker according to claim 1, wherein
the stress-relieving member includes
a first reinforcing plate interposed between and fixed to the first reinforcing member and the side surface of the main pipe, and
a second reinforcing plate interposed between and fixed to the second reinforcing member and the side surface of the main pipe.

8. The gas circuit breaker according to claim 7, wherein
the first reinforcing plate has a curved shape with an inside diameter equal to an outside diameter of the main pipe, and
the second reinforcing plate has a curved shape with an inside diameter equal to the outside diameter of the main pipe.

9. The gas circuit breaker according to claim 7, further comprising:
a flange-shaped first base plate provided to the first branch pipe; and
a flange-shaped second base plate provided to the second branch pipe, wherein
the first reinforcing member is fixed to a surface of the first base plate on the main pipe side, fixed to the side surface of the first branch pipe, and fixed to the first reinforcing plate, and
the second reinforcing member is fixed to a surface of the second base plate on the main pipe side, fixed to the side surface of the second branch pipe, and fixed to the second reinforcing plate.

10. The gas circuit breaker according to claim 9, further comprising:
a plate-shaped third reinforcing member disposed parallel to the first reinforcing member above the axis, fixed to the side surface of the first branch pipe on a side opposite the second branch pipe side, fixed to a surface of the first base plate on the main pipe side, and fixed to the side surface of the main pipe;
a plate-shaped fourth reinforcing member disposed at right angles to the first reinforcing member, fixed to the side surface of the first branch pipe, fixed to the surface of the first base plate on the main pipe side, and fixed to the side surface of the main pipe;
a plate-shaped fifth reinforcing member disposed at right angles to the first reinforcing member, disposed opposite the fourth reinforcing member in a direction orthogonal to the first reinforcing member, fixed to the side surface of the first branch pipe, fixed to the surface of the first base plate on the main pipe side, and fixed to the side surface of the main pipe;
a plate-shaped sixth reinforcing member disposed parallel to the first reinforcing member above the axis, fixed to the side surface of the second branch pipe on a side opposite the first branch pipe side, fixed to the surface of the second base plate on the main pipe side, and fixed to the side surface of the main pipe;
a plate-shaped seventh reinforcing member disposed at right angles to the second reinforcing member, fixed to the side surface of the second branch pipe, fixed to the surface of the second base plate on the main pipe side, and fixed to the side surface of the main pipe; and
a plate-shaped eighth reinforcing member disposed at right angles to the second reinforcing member, disposed opposite the seventh reinforcing member in a direction orthogonal to the first reinforcing member, fixed to the side surface of the second branch pipe, fixed to the surface of the second base plate on the main pipe side, and fixed to the side surface of the main pipe, wherein
the stress-relieving member includes
a third reinforcing plate interposed between and fixed to the third reinforcing member and the side surface of the main pipe,
a fourth reinforcing plate interposed between and fixed to the fourth reinforcing member and the side surface of the main pipe,
a fifth reinforcing plate interposed between and fixed to the fifth reinforcing member and the side surface of the main pipe,
a sixth reinforcing plate interposed between and fixed to the sixth reinforcing member and the side surface of the main pipe,
a seventh reinforcing plate interposed between and fixed to the seventh reinforcing member and the side surface of the main pipe, and
an eighth reinforcing plate interposed between and fixed to the eighth reinforcing member and the side surface of the main pipe.
